(19) United States
(12) Patent Application Publication
(10) Pub. No.: US 2016/0362634 A1
(43) Pub. Date: Dec. 15, 2016

(54) All-In-One Air Cleaner/Odor Eliminator, Surface Disinfectant and Surface Multipurpose/All Purpose Cleaner

(71) Applicant: Andrew J. Kielbania, JR., Chalfont, PA (US)

(72) Inventor: Andrew J. Kielbania, JR., Chalfont, PA (US)

(21) Appl. No.: 15/174,404

(22) Filed: Jun. 6, 2016

Related U.S. Application Data
(60) Provisional application No. 62/171,471, filed on Jun. 5, 2015.

(51) Int. Cl. C11D 1/90; C11D 1/72; A01N 25/30; C11D 3/20; C11D 3/48; A01N 33/12; C11D 1/75; C11D 1/66

(52) U.S. Cl. CPC C11D 1/90; C11D 1/75; C11D 1/72; C11D 1/66; C11D 3/2086; C11D 3/48; A01N 33/12; A01N 25/30

(57) ABSTRACT

Embodiments of the present invention provides for superior all-in-one air cleaner/odor eliminator, surface disinfectant and surface multipurpose/all purpose cleaner all purpose or multipurpose cleaners that are compliant with local and federal VOC (volatile organic compound) regulations, are not flammable, avoids use of ingredients which detract from the worlds food supply, are mild to surfaces and materials of construction with a near neutral pH, clean with less work and in a shorter period of time compared to currently commercial available cleaners while also providing superior air cleaning/odor elimination and broad spectrum disinfection of surfaces.

Embodiments of the present invention also provide for a superior all-in-one air cleaner/odor eliminator, surface disinfectant and surface multipurpose/all purpose cleaner which uses environmentally friendly components, has a near neutral pH which allows it to be used on various surfaces, which is safe for use on colored surfaces or items, which has low VOC's, which has no abrasives, which has no phosphates or phosphorous containing compounds, which has no anionic surfactants, which has no added electrolytic salts, which has no heavy metals such as zinc, copper and other transition metals, which has no harsh or sensitizing preservatives, which has no silicates or silicones. The formulation according to the present invention has superior cleaning of soils, stains or grease and requires less work to clean surfaces compared to currently available commercial cleaners while also providing superior air cleaning/odor elimination and broad spectrum disinfection of surfaces.

### BACKGROUND

Many of today's odor eliminators use perfumes and fragrances to mask odors. Few are actually capable of cleaning the air and totally eliminating odors. Also, there are very few odor eliminators which can clean surfaces. They essentially have no cleaning capabilities. Furthermore, fewer if any odor eliminators have combined surface cleaning and surface disinfecting. They have essentially no functionality beyond mediocre odor control. The lack of a single product which can eliminate odors, not mask odors, superiorly clean surfaces and also disinfect surfaces has been due in large part to the incompatibility or antagonistic characteristics of the active ingredients components of odor eliminators, surface cleaners and surface disinfectants. The present invention overcomes these issues and results in formulations that actually clean the air of odors and toxic gases, provide superior cleaning performance of surfaces with less work, and also provides broad spectrum disinfecting of surfaces.

Related Art, which is incorporated herein by reference:

U.S. Pat. No. 8,992,889

U.S. Pat. No. 8,961,680

U.S. Pat. No. 8,927,482

U.S. Pat. No. 8,871,186

U.S. Pat. No. 8,835,370

U.S. Pat. No. 8,822,397

U.S. Pat. No. 8,821,648

U.S. Pat. No. 8,802,611

U.S. Pat. No. 8,785,366

U.S. Pat. No. 8,697,622

U.S. Pat. No. 8,641,827

U.S. Pat. No. 8,617,317

U.S. Pat. No. 8,591,963

U.S. Pat. No. 8,383,569

U.S. Pat. No. 8,222,194

U.S. Pat. No. 8,211,847

U.S. Pat. No. 7,887,759

U.S. Pat. No. 7,786,068

U.S. Pat. No. 7,199,094

U.S. Pat. No. 7,147,822

U.S. Pat. No. 6,815,405

U.S. Pat. No. 6,762,162

U.S. Pat. No. 6,616,922

U.S. Pat. No. 6,407,051

U.S. Pat. No. 6,277,805

U.S. Pat. No. 6,255,270

U.S. Pat. No. 6,191,087

U.S. Pat. No. 5,990,064

U.S. Pat. No. 5,977,054

U.S. Pat. No. 5,965,514

U.S. Pat. No. 5,763,386

U.S. Pat. No. 5,573,702

U.S. Pat. No. 5,454,984

U.S. Pat. No. 5,435,935

U.S. Pat. No. 5,227,085

U.S. Pat. No. 5,076,960

U.S. Pat. No. 4,565,647

U.S. Pat. No. 4,444,790

U.S. Pat. No. 4,420,484

U.S. Pat. No. 4,316,824

### SUMMARY OF THE INVENTION

Embodiments of the present invention provides for superior all-in-one air cleaner/odor eliminator, surface disinfectant and surface multipurpose/all purpose cleaner all purpose or multipurpose cleaners that are compliant with local and federal VOC (volatile organic compound) regulations, are not flammable, avoids use of ingredients which detract from the worlds food supply, are mild to surfaces and materials of construction with a near neutral pH, clean with less work and in a shorter period of time compared to currently commercial available cleaners while also providing superior air cleaning/odor elimination and broad spectrum disinfection of surfaces.

Embodiments of the present invention also provide for a superior all-in-one air cleaner/odor eliminator, surface disinfectant and surface multipurpose/all purpose cleaner which uses environmentally friendly components, has a near neutral pH which allows it to be used on various surfaces, which is safe for use on colored surfaces or items, which has low VOC's, which has no abrasives, which has no phosphates or phosphorous containing compounds, which has no anionic surfactants, which has no added electrolytic salts, which has no heavy metals such as zinc, copper and other transition metals, which has no harsh or sensitizing preservatives, which has no silicates or silicones. The formulation according to the present invention has superior cleaning of soils, stains or grease and requires less work to clean surfaces compared to currently available commercial cleaners while also providing superior air cleaning/odor elimination and broad spectrum disinfection of surfaces.

### DETAILED DESCRIPTION OF THE INVENTION

The present invention overcomes the prior art issues and results in formulations that are capable of cleaning the air of odors and toxic gases, provide superior cleaning performance of surfaces with less work, and also provide broad spectrum disinfecting of surfaces. Embodiments of the present invention may be water based. In addition, the formulations of the present invention have broad utility and address the unmet needs of several specialty and specific odor elimination situations. For example, the formulations of the present invention can eliminate odors in clumping kitty litter without clumping the kitty litter. In contrast, the current state of the art odor eliminators will clump the clumping kitty litter which is undesirable. Therefore the present invention provides for concurrent odor elimination of the kitty litter and no detrimental clumping of the kitty litter which allows continued use of the kitty litter with no need to discard any clumped kitty litter. The present invention provides air cleaners and odor eliminators that can be used to clean the air in restaurant grease pits which is a particularly difficult problem. This is a difficult problem since current state of the art odor eliminators cannot mix with grease to eliminate the odor. The present invention overcomes this prior art drawback.

Odors can be the result of a single odoriferous chemical or a complex mixture of odoriferous chemicals. This complex mixture can be difficult to totally eliminate which is a major reason why masking agents or fragrances are used in today's air fresheners.

Similar characteristics are associated with surface cleaners. Very effective surface cleaners must be capable of removing the toughest soils, stains and greases. This requires a surface cleaner which can eliminate the complex chemical constituents of soils, stains and oily greases. The formulations of the present invention can be used to clean a wide variety of porous surfaces such as fabrics, carpeting, porous grout, porous masonry, stone, wood, paper, clothing and nonporous surfaces such as metals, plastics, painted or sealed surfaces, glass, jewelry, porcelain, rubber, elastomers, sealants, caulking, tile, grout, ceramics, composite substrates such as flooring, wallboard and white boards. The formulations of the present invention can be applied by spray, aerosol, atomize, flooding, mop, sponge, cloth, automatic cleaners, metered dosing, fog, spray curtain and pouring. The prior art teaches that compared to anionic cleaners, cationic based cleaners are mediocre in performance. Contrary to the prior art, the cationic formulations of the present invention are surprisingly superior surface cleaners. The formulations of the present invention are superior cleaners and require less work to clean compared to currently available cleaners. The formulations of the present invention require less than 8 foot pounds of work to clean as described in the example section of this application. More preferably, the formulations of the present invention require less than 4 foot pounds of work to clean. Most preferably, the formulations of the present invention require less than 1 foot pounds of work to clean.

Effective surface disinfectants should be broad spectrum capable of eliminating or killing both gram positive and gram negative types of harmful microorganisms.

An additional characteristic recently required of odor eliminators, surface cleaners and, or disinfectants is the need to be environmentally friendly, particularly in the area of legislated regulations controlling the volatile organic compound, VOC, content of these types of products. The limitation of VOC's is directed at preventing or reducing the formation of greenhouse gases and related global warming effect. The reduction in VOC's in products has also resulted in the diminishment of cleaner performance because substitutes for VOC's are usually poorly soluble or insoluble in water. Water is the preferred base or carriers for cleaners in general because of its environmental friendliness. These product performance requirements and environmental constraints make an all-in-one air cleaner or odor eliminator, surface cleaner and surface disinfectant very complex and very difficult to achieve with prior art approaches. The formulations of the present invention provide a new and as of now an unachieved level of superior air cleaning or odor elimination, surface cleaning and surface disinfecting performance all achieved in an all-in-one formulation or product.

To achieve air cleaning and/or odor eliminating capabilities in the present invention, cationic components can be used. These cationic components are capable of complexing or sequestering odor causing molecules. In addition these cationic components can clean the air by flocculating and removing particulates from the air. Typical cationic components of the present invention include betaines, amine oxides, quaternary ammonium compounds, amphoteric compounds, amine and amine salts or mixtures thereof. The preferred betaines of the present invention include coco-betaine, cetyl-betaine, oleyl-betaine, octyl-betaine, cocamidopropyl-betaine, lauryl-betaine, caprylamidopropyl-betaine. The most preferred betaines are coco-betaine, octyl-betaine, lauryl-betaine, cocamidopropyl-betaine. The levels of betaine in the present invention range from 0.05% to 5%. More preferably the betaine range is from 0.1% to 3%. Most preferred the betaine content of the present invention is from 0.2% to 2%. The preferred amine oxides of the present invention include lauramidopropylamine oxide, octylamine oxide, cocamidopropylamine oxide, decylamine oxide, lauramine oxide, cocamine oxide, myristamine oxide. The most preferred amine oxides of the present invention are decyl amine oxide, lauramine oxide, cocamine oxide and myristamine oxide. The levels of amine oxide in the formulations of the present invention range from 0.05% to 5%. More preferably the level of amine oxide in the present invention is from 0.1% to 3%. The most preferred range of amine oxide in the present invention is from 0.2% to 2%. The preferred quaternary ammonium compounds in the present invention include dimethyl didecyl ammonium chloride, decyl dimethyl benzyl ammonium chloride, n-alkyl C10 to C14 dimethyl benzyl ammonium saccharinate, n-alkyl C10 to C14 dimethyl benzyl ammonium chloride, dodecyl dimethyl benzyl ammonium chloride, myristyl trimethyl ammonium bromide. The most preferred quaternary ammonium compounds in the present invention are n-alkyl C10 to c14 dimethyl benzyl ammonium chloride and dimethyl didecyl ammonium chloride and mixtures thereof. The levels of quaternary ammonium compounds in the formulations of the present invention range from 0.01% to 3%. More preferably the level of quaternary ammonium compounds in the present invention is from 0.10% to 2%. The most preferred range of quaternary ammonium compounds in the present invention is from 0.15% to 1%. The preferred amphoteric compounds of the present invention include sodium cocoamphoacetate, sodium lauroamphoacetate, sodium cocoamphodiacetate, disodium cocoamphodiprpionate, disodium lauroamphodiacetate, sodium cocoamphopropionate, sodium lauriminodipropionate, disodium capryloamphodiacetate, sodium capryloamphopropionate, disodium capryloamphodipropionate. The most preferred amphoteric compounds of the present invention are sodium cocoamphoacetate, sodium lauroamphoacetate, sodium cocoamphodiacetate, disodium cocoamphodiprpionate, disodium lauroamphodiacetate, sodium cocoamphopropionate. The levels of amphoteric compounds in the present invention range from 0.05% to 5%. More preferably the amphoteric compound range is from 0.1% to 3%. Most preferred the amphoteric compound content of the present invention is from 0.2% to 2%. The preferred amine and amine salts in the present invention include cocamidopropyl dimethyl amine, cocamidopropyl dimethyl propionate, isostearamidopropyl morpholine, hexahydro-1,3,5-tris(2-hydroethyl)triazine. The most preferred amine and amine salts of the present invention are cocamidopropyl dimethyl amine, cocamidopropyl dimethyl propionate. The levels of amine and amine salts in the present invention range from 0.1% to 6%. More preferably the amine and amine salt compound range is from 0.5% to 3%.

Additional components can be included in the present invention as long as they maintain and do not interfere with the cationic nature and characteristics of the formulations of the present invention. Examples of such components include nonionic surfactants such as linear straight chain and branched alkyl (C2 to C11) ethoxylates (EO 2 to 10), (available from Stepan Company, Dow Chemical and Air products Company), as linear straight chain and branched alkyl (C2 to C11) ethoxylates (EO 2 to 10 ester derivatives, alkyl polysorbate ethoxylates (available from Spectrum Chemical Company), polyethylene oxide-polypropylene oxide-polyethylene oxide and polypropylene oxide-polyethylene oxide-polypropylene oxide triblock copolymers (available from BASF Corporation as Pluronic and Pluronic R Surfactants). Preferred nonionic surfactants include Pluronic F-108 (Pluronic® F-108 surfactant is an ethylene oxide-propylene oxide-ethylene oxide triblock copolymer with an average molecular weight of 14,000, having a polyethylene oxide content of 80% and the molecular weight of the polypropylene oxide block of 3250), polyoxyethylene (20)sorbitan monolaurate, polyoxyethylene (20)sorbitan monopalmitate, polyoxyethylene (20)sorbitan monooleate), polyoxyethylene (20)sorbitan monostearate, diethylene glycol mono ethyl ether, diethylene glycol butyl ether, diethylene glycol hexyl ether, 2-(2-butoxyethoxy) ethyl acetate, dipropylene glycol butyl ether, dipropylene glycol ethyl ether, dipropylene glycol hexyl ether, decyl alcohol ethylene oxide 3, decyl alcohol ethylene oxide 4, decyl alcohol ethylene oxide 6, decyl alcohol ethylene oxide 9, C11 fatty alcohol ethylene oxide 3, C11 fatty alcohol ethylene oxide 5, C11 fatty alcohol ethylene oxide 7, C11 fatty alcohol ethylene oxide 9, C9/11 fatty alcohol ethylene oxide 6, C9/11 fatty alcohol ethylene oxide 8, C9/11 fatty alcohol ethylene oxide 2.7, C8/10 fatty alcohol ethylene oxide 1, C8/10 fatty alcohol ethylene oxide 2.2. The most preferred nonionic surfactants of the present invention are Pluronic F-108, polyoxyethylene (20)sorbitan monolaurate, polyoxyethylene (20)sorbitan monopalmitate, polyoxyethylene (20)sorbitan monooleate, diethylene glycol mono ethyl ether, diethylene glycol butyl ether, diethylene glycol hexyl ether, 2-(2-butoxyethoxy) ethyl acetate, dipropylene glycol butyl ether, dipropylene glycol ethyl ether, dipropylene glycol hexyl ether, decyl alcohol ethylene oxide 3, decyl alcohol ethylene oxide 4, C9/11 fatty alcohol ethylene oxide 6, C9/11 fatty alcohol ethylene oxide 8, C9/11 fatty alcohol ethylene oxide 2.7. The levels of nonionic surfactants in the present invention range from 0.1% to 9%. More preferably the nonionic surfactant range is from 0.5% to 7%. The most preferred range for the nonionic surfactants is from 1% to 6%.

To further enhance the attractiveness and overall performance, the pH of the air cleaner/odor eliminator, surface cleaner, surface disinfectant of the present invention may be near neutral. The preferred pH range of the present invention is from 4 to 11. More preferably the pH range of the formulations of the present invention is from 5 to 9.5. Most preferably the pH range of the formulations of the present invention is from 6 to 9. While current state of the art cleaners require very acidic, less than pH 4, or very caustic, greater than pH 11, to be effective, the formulations of the present invention can be effective at near neutral pH. The near neutral pH provides formulations which are mild to surfaces and skin. The near neutral pH also enhances the stability of formulation components by, for example, avoiding hydrolysis of sensitive formulation components. Near neutral formulations of the present invention are contrary to current state of the art which teaches effective cleaners should have a very low pH or very high pH values.

According to certain formulations of the present invention, the pH may be controlled by various pH modifiers and buffers such as acetic acid, sodium acetate, citric acid, trisodium citrate, benzoic acid, sodium benzoate, various amines such as ethylene diamine, diethylene triamine, triethylene tetramine, ammonium hydroxide, ethanol amine, diethanol amine, triethanol amine, various salts such as sodium hydroxide, potassium hydroxide, boric acid, borax, calcium oxide, calcium hydroxide, magnesium hydroxide, sodium carbonate, sodium bicarbonate, sodium sesquicarbonate and various mineral acids such as sulfuric acid, hydrochloric acid, nitric acid and other pH controllers well known in the art. Salts or electrolytes such as sodium chloride, potassium chloride, sodium bromide, potassium bromide, sodium sulfate, potassium sulfate and oxidants such as sodium persulfate and potassium persulfate can be excluded from the formulations of the present invention.

One or more components included in the formulations of the present invention may be water soluble. Water is the preferred carrier for the formulations of the present invention. The water content in the present invention can vary from 15% to 98%. The preferred water content is from 20% to 96%. The most preferred water content range is from 25% to 95%.

The formulations of the present invention can be free of anionic surfactants such as anionic coupling agents like xylene sulfonate, anionic surfactants such as sodium sulfates, sodium sulfonates, sodium or ammonium phosphates, sodium sulfosuccinates. Such anionic components render the cationic components of the present invention ineffective since they will react or complex with them. The formulations of the present invention may also be free of phosphates or phosphorous compounds, heavy metals such as copper, zinc and other transition metals, methyl and chloro isothiazolinones, ingredients that detract from the world's food supply such as fermentation derived ethanol, silicates, abrasives, phenolics, alkyl phenol ethoxylate surfactants)APES), sodium hypochlorite, silicones, and chlorinated aromatic compounds.

### EXAMPLES

Odor Elimination and Toxic Gas Elimination Measurements

Formaldehyde Tests:

At time point 1, a sealed static chamber (approximately 40 gallons volume) was charged with 0.2 cc of 2% formaldehyde solution. The formaldehyde was allowed to equilibrate and at time points 2 and 3, the formaldehyde was measured with Gastec detection tube #91L (Available from Instrument Depot). After the measurement at time point 3, 10 ml of the formulation of the present invention example #2 (or separately repeated with Febreze Air Effects—Proctor and Gamble Company, Renuzit® Renew—Dial Corporation a Henkel Company, Glade Fabric and Air Odor Eliminator—SC Johnson Company, or water) was introduced (sprayed) into the chamber. At time point 4 the formaldehyde was measured. The formaldehyde levels were measured again at time points 5 and 6.

The results indicate that a formulation of the present invention example #2 rapidly reduced the formaldehyde upon spraying into the chamber and the formaldehyde level dropped to zero and remained zero. With Febreze Air Effects—Proctor and Gamble Company, Renuzit Renew—Dial Corporation a Henkel Company, Glade® Fabric and Air Odor Eliminator—SC Johnson Company the formaldehyde level dropped slightly and did not drop to zero. Versus the water control, with Febreze Air Effects—Proctor and Gamble Company, Renuzit® Renew—Dial Corporation a Henkel Company, Glade® Fabric and Air odor Eliminator—SC Johnson Company is only slightly better than water at eliminating formaldehyde. The results are in Table 1 below.

TABLE 1
Formaldehyde Elimination Test

| | Initial | ppm | ppm | ppm |
|---|---|---|---|---|
| | ppm of | after 7 | after 22 | after 37 |
| Liquid Tested | formaldehyde | minutes | minutes | minutes |
| Present | 3 | 0 | 0 | 0 |
| invention | | | | |
| example # 2 | | | | |
| Water Control | 2.8 | 1.7 | 1.4 | 1.4 |
| Febreze | 2.7 | 1.4 | 0.8 | 0.7 |
| Renuzit | 2.7 | 0.8 | 0.7 | 0.6 |
| Glade | 2.6 | 0.8 | 0.6 | 0.6 |

Formaldehyde is associated with a large variety of smoke (burnt wood, burnt paper, cigar, cigarette), food, cooking, decaying material and materials of construction odors. The present invention eliminates these types of odors and more.

The results in Table 1 indicate that the present invention outperform leading commercial odor eliminators. The formulations of the present invention (such as example #2) can remove 3 ppm of formaldehyde in seven minutes or less to essentially zero or an undetectable level.

Acetic Acid Tests:

At time point 1 a sealed static chamber was charged with 0.1 g of 20% acetic acid solution. The acetic acid was allowed to equilibrate and at time point 2 (approximately 40 gallons volume) the acetic acid was measured with Gastec detection tube #81L (available from Instrument Depot). After the measurement at time point 2, 10 ml of the formulation of the present invention example #2 (or repeated separately with Febreze Air Effects—Proctor and Gamble Company, Renuzit® Renew—Dial Corporation a Henkel Company, Glade Fabric and Air Odor Eliminator—SC Johnson Company or water) was introduced (sprayed) into the chamber. At time point 3 the acetic acid was measured. The acetic acid levels were measured again at time points 4 and 5.

The results indicate that the formulation of the present invention example #2 rapidly reduced the acetic acid upon spraying into the chamber and the acetic acid level dropped to zero and remained zero. With Febreze Air Effects—Proctor and Gamble Company, Renuzit® Renew—Dial Corporation a Henkel Company, Glade Fabric and Air Odor Eliminator—SC Johnson Company the acetic acid level dropped slightly and did not drop to zero. Versus the water control, Febreze Air Effects—Proctor and Gamble Company, Renuzit® Renew—Dial Corporation a Henkel Company, Glade Fabric and Air Odor Eliminator—SC Johnson Company is only slightly better than water at eliminating acetic acid. The results are in Table 2 below.

TABLE 2
Acetic Acid Elimination Test

| | Initial | ppm | ppm | ppm |
|---|---|---|---|---|
| | ppm of | after 7 | after 22 | after 37 |
| Liquid Tested | acetic acid | minutes | minutes | minutes |
| Present | 5 | 0.1 | 0 | 0 |
| invention | | | | |
| example # 2 | | | | |
| Water Control | 5 | 4.4 | 3.9 | 3.8 |
| Febreze | 5 | 3.9 | 3.2 | 3.2 |
| Renuzit | 5 | 3.2 | 2.4 | 2.1 |
| Glade | 5 | 3.8 | 2.9 | 2.7 |

Acetic acid is associated with a large variety of smoke, food, body odors, cooking, decaying material, adhesives and materials of construction odors. The present invention eliminates these types of odors and more.

The results in Table 2 indicate that the present invention outperform leading commercial odor eliminators. The formulations of the present invention (such as example #2) can remove 5 ppm of acetic acid in twenty two minutes or less to essentially zero or an undetectable level.

In order to facilitate and expedite the odor/gas elimination testing, the 40 gallon chamber was replaced with a clean one gallon plastic bottle. For the formaldehyde testing, 0.2 ml of a 2% aqueous formaldehyde solution was injected into the bottle. The bottle was capped for 5 minutes and then a gas measurement was taken with a Gastek 91L gas detection tube. Then 10 ml of liquid being tested was sprayed into the bottle. The bottle was capped. After 5 minutes a gas measurement was taken with a Gastek 91L gas detection tube. Water was used as a control liquid. The results are in Table 3.

TABLE 3
Formaldehyde Elimination Test

| | Initial ppm | ppm formaldehyde |
|---|---|---|
| Liquid Tested | formaldehyde | after 5 minutes |
| Water Control | 25 | 8 |
| Example # 2 of the present | 25 | 0 |
| invention | | |
| Example # 3 of the present | 25 | 0 |
| invention | | |
| Example # 9 of the present | 25 | 0.2 |
| invention | | |
| Example # 10 of the present | 25 | 0 |
| invention | | |
| Example # 11 of the present | 25 | 0 |
| invention | | |

This odor/gas elimination test was repeated with acetic acid with 0.4 ml of 5% acetic acid aqueous solution was initially injected into the bottle. The test proceeded as described above except a 15 minutes duration passed after the test liquid was sprayed into the bottle and the testing for acetic acid with a Gastek 81L gas detection tube was made. Again, water was used as a control liquid and the results are in Table 4.

TABLE 4
Acetic Acid Elimination Test

| | Initial ppm | ppm acetic acid |
|---|---|---|
| Liquid Tested | acetic acid | after 15 minutes |
| Water Control | 16 | 4 |
| Example # 2 of the present | 16 | 0 |
| invention | | |
| Example # 3 of the present | 16 | 0 |
| invention | | |
| Example # 9 of the present | 16 | 0 |
| invention | | |
| Example # 10 of the present | 16 | 0 |
| invention | | |
| Example # 11 of the present | 16 | 0 |
| invention | | |

Work to Clean Measurements

The preparation of the air cleaners/odor eliminators, surface cleaners and surface disinfectants of the present invention was conducted at room temperature in a 250 ml beaker equipped with a magnetic stir bar. With stirring, the ingredients were charged into the beaker sequentially as listed with a five minute interval between ingredient additions. Upon completion of the addition of all the ingredients, agitation is continued and the pH is measured. The ingredients of the formulations of the present invention are available from Sigma Aldrich Company, Dow Chemical Company, BASF Corporation, Stepan Company, Walmart, and Target.

The work exerted to clean was measured as follows. SwiftLock Tuscany Stone Laminate Flooring D2788 purchased at Home Depot was marked with an approximately one inch long line of permanent marker. Parallel to this initial line another line was drawn using a different permanent marker. This procedure was repeated until all five different permanent markers were used. The parallel lines were spaced equally apart and the total distance from the first line to the last line was six inches. The permanent markers lines were allowed to dry 5 minutes. Then approximately 3 ml to 4 ml of cleaner was evenly applied and covered all 5 lines. The cleaner was allowed to have a 10 second contact time and then a flat microfiber towel (Microtex® Cleaning Microfiber Towel by Calderon Textiles available at Walmart) with a one quart bottle containing water to give a total weight of 2 pounds was pulled across the lines with a back and forth scrubbing motion until all 5 lines were eliminated or until a total of 60 back and forth scrubbing motions were completed. The portion of the microfiber towel with the quart bottle was drawn across the lines. After 10 back and forth scrubbing motions another 3 ml to 4 ml of cleaner was applied if all the lines have not been eliminated. This additional 3 ml to 4 ml of cleaner was applied after every set of 10 scrubbing motions. After 60 back and forth scrubbing motions if any of the permanent marker lines remained then the cleaner was considered as failing to clean or eliminate the permanent stains and the test stopped for that particular cleaner. The cylindrical one quart high density polyethylene carafe bottle had a circular base with a diameter of approximately 3.25 inches. The bottle with water weighed 2 pounds. The force used to pull the microfiber towel with bottle on top was measured with a scale, Berkley Portable Digital Scale BTDES 50-1 by Jarden Corporation purchased at Walmart. The scale was pulled in the direction of the displacement. The work was calculated by W=Fs, where W is work in this case foot-pounds, F is the constant force to cause the displacement measured by the scale, and s is the displacement in feet.

In the test the following 5 black permanent markers were used to stain the Swift Lock Plus 30 Tuscany Stone Laminate Flooring floor tile: Sharpie Permanent Marker; INC Permanent Marker; TUL Permanent Marker; BIC Permanent Marker; Office Max Permanent Marker. These markers were purchased at Walmart, Target and Office Max.

Table 5 contains the results of the work to clean for various leading commercially available consumer cleaners and disinfectants and examples of the present invention.

TABLE 5
Work to Clean for Various Cleaners

| | Work in | |
|---|---|---|
| | Foot- | |
| | Pounds | Comments |
| Fantastic ® Scrubbing Bubbles ® All | 35.6 | Stains remain |
| Purpose Cleaner - S C Johnson | | |
| Lysol ® All Purpose Cleaner | 37.5 | Stains remain |
| Complete - Reckitt Benckiser | | |
| Formula 409 ® Cleaner Degreaser | 30.0 | Stains remain |
| Disinfectant - Clorox | | |
| Formula 409 ® All Purpose Cleaner - | 33.7 | Stains remain |
| Clorox | | |
| Lysol ® Power and Free Multipurpose | 30.0 | Stains remain |
| Cleaner - Reckitt Benckiser | | |
| Clean Up ® Bleach - Clorox | 31.5 | All stains |
| | | removed |
| Clorox Anywhere Hard Surface ™ | 46.9 | Stains remain |
| Cleaner - Clorox | | |
| Windex ® Natures Source ® 99% | 41.3 | Stains remain |
| Natural - S C Johnson | | |
| Example # 1 of the present invention | 6.3 | All stains |
| | | removed |
| Example # 2 of the present invention | 0.2 | All stains |
| | | removed |
| Example # 3 of the present invention | 1.6 | All stains |
| | | removed |
| Example # 4 of the present invention | 1.3 | All stains |
| | | removed |
| Example # 5 of the present invention | 1.4 | All stains |
| | | removed |
| Example # 6 of the present invention | 1.7 | All stains |
| | | removed |
| Example # 7 of the present invention | 1.0 | All stains |
| | | removed |
| Example # 8 of the present invention | 0.3 | All stains |
| | | removed |
| Example # 9 of the present invention | 0.4 | All stains |
| | | removed |
| Example # 10 of the present invention | 0.4 | All stains |
| | | removed |
| Example # 11 of the present invention | 0.4 | All stains |
| | | removed |

The results in Table 5 show that the examples of the present invention are superior to current leading commercial products which cannot provide the added performance features of the formulations of the present invention.

Table 6 contains the results of the work to clean for various leading commercially available commercial/industrial cleaners and disinfectants and examples of the present invention.

TABLE 6
Work to Clean for Various Cleaners

| | Work in | |
|---|---|---|
| | Foot- | |
| | Pounds | Comments |
| Zep Commercial ® Fast 505 ® Industrial | 8.0 | All stains |
| Cleaner & Degreaser - Zep | | removed |
| Simple Green ® Industrial Cleaner & | 9.4 | All stains |
| Degreaser - Sunshine Makers | | removed |
| Spitfire ® RTU Cleaner - S C Johnson | 1.5 | All stains |
| | | removed |
| Tough Duty ® NB - Spartan Chemical | 24.4 | Stains remain |
| Betco ® Speedex RTU Degreaser - | 2.0 | All stains |
| Betco | | removed |
| Speedball ® Power Cleaner - | 1.3 | All stains |
| S C Johnson | | removed |
| Simple Green ® Crystal Industrial | 9.5 | All Stains |
| Cleaner & Degreaser - Sunshine Makers | | removed |
| Example # 1 of the present invention | 6.3 | All stains |
| | | removed |
| Example # 2 of the present invention | 0.2 | All stains |
| | | removed |
| Example # 3of the present invention | 1.6 | All stains |
| | | removed |
| Example # 4 of the present invention | 1.3 | All stains |
| | | removed |
| Example # 5 of the present invention | 1.4 | All stains |
| | | removed |
| Example # 6 of the present invention | 1.7 | All Stains |
| | | removed |
| Example # 7 of the present invention | 1.0 | All stains |
| | | removed |
| Example # 8 of the present invention | 0.3 | All stains |
| | | removed |
| Example # 9 of the present invention | 0.4 | All stains |
| | | removed |
| Example # 10 of the present invention | 0.4 | All stains |
| | | removed |
| Example # 11 of the present invention | 0.4 | All stains |
| | | removed |

The results in Table 6 show that the examples of the present invention are superior to current leading commercial products which cannot provide the added performance features of the formulations of the present invention.

The preparation of the formulation of the present invention was conducted at room temperature in a 250 ml beaker equipped with a magnetic stir bar. With stirring, the ingredients were charged into the beaker sequentially as listed with a five minute interval between ingredient additions. Upon completion of the addition of all the ingredients, agitation is continued and the pH is measured. The ingredients of the formulations of the present invention are available from Sigma Aldrich Company, Dow Chemical Company, BASF Corporation, Stepan Company and McIntrye Group a Rhodia Company.

Formulation Examples of the Present Invention

Formulation Examples of the Present Invention are contained in Table 7.

TABLE 7
Formulation Examples of the Present Invention

| | Example | Example | Example | Example | Example | Example |
|---|---|---|---|---|---|---|
| Ingredient in grams | 1 | 2 | 3 | 4 | 5 | 6 |
| Water | 85 | 85 | 85 | 85 | 85 | 85 |
| Cocamidopropyl | 1 | 1 | 1 | 1 | 1 | 1 |
| betaine - 30% | | | | | | |
| Lauramine oxide - | 0.5 | 0.5 | — | 0.5 | 0.5 | 0.5 |
| 30% | | | | | | |
| Myristamine oxide - | — | — | 0.5 | — | — | — |
| 30% | | | | | | |
| C9-C11 fatty alcohol | 0.5 | 0.5 | 0.5 | 0.5 | 0.5 | 0.5 |
| 6EO | | | | | | |
| Diethylene glycol | — | 3 | 3 | 3 | 3 | — |
| butyl ether | | | | | | |
| 2-(2-butoxy ethoxy) | — | 3 | 3 | 3 | 3 | — |
| ethyl acetate | | | | | | |
| Diethylene glycol | 2 | 3 | 3 | 3 | 3 | 3 |
| hexyl ether | | | | | | |
| C12-C16 alkyl | — | — | — | 0.2 | — | — |
| dimethyl benzyl | | | | | | |
| ammonium chloride | | | | | | |
| Didecyl dimethyl | 0.2 | 0.2 | 0.2 | — | — | — |
| ammonium chloride | | | | | | |
| Monoethanol amine | 1 | 1 | 1 | 0.5 | 0.5 | 0.5 |
| Citric acid | 0.1 | 0.1 | 0.1 | 0.1 | 0.1 | 0.1 |

Formulation Examples of the Present Invention are contained in Table 7.

| | Example | Example | Example | Example | Example |
|---|---|---|---|---|---|
| Ingredient | 7 | 8 | 9 | 10 | 11 |
| Water | 85 | 85 | 85 | 85 | 85 |
| Cocamidopropyl | 1 | 1 | 1 | 1 | 1 |
| betaine - 30% | | | | | |
| Lauramine oxide - | 0.5 | 0.5 | 0.5 | 0.5 | 0.5 |
| 30% | | | | | |
| Myristamine oxide - | — | — | — | — | — |
| 30% | | | | | |
| C9-C11 fatty alcohol | 0.5 | 0.5 | 0.5 | 0.5 | 0.5 |
| 6EO | | | | | |
| Diethylene glycol | — | 3 | 3 | 4 | 4 |
| butyl ether | | | | | |
| 2-(2-butoxy ethoxy) | — | 3 | 3 | 4 | 4 |
| ethyl acetate | | | | | |
| Diethylene glycol | 3 | 3 | 1 | 4 | 3 |
| hexyl ether | | | | | |
| C12-C16 alkyl | 0.2 | 0.2 | 0.2 | 0.2 | — |
| dimethyl benzyl | | | | | |
| ammonium chloride | | | | | |
| Didecyl dimethyl | — | — | 0.2 | — | 0.2 |
| ammonium chloride | | | | | |
| Monoethanol amine | 0.5 | 0.5 | 1 | 1 | 1 |
| Citric acid | 0.1 | 0.1 | 0.1 | o.1 | 0.1 |

Formulations which contain C12-C16 dimethyl benzyl ammonium chloride or didecyl dimethyl ammonium chloride or combinations of them are recognized as effective disinfectants.

Examples 12 and 13 demonstrate that formulations with low water content are provided by the present invention.

### Example 12

The composition of example 12 is: water—12.0 g; cocamidopropyl betaine (30%)—0.3 g; lauryl amine oxide (30%) 0.3 g; C9-C11 fatty alcohol 6EO—0.2 g; diethylene glycol butyl ether—35.0 g; citric acid—0.1 g; monoethanol amine—2.0 g; C12-C16 alkyl dimethyl benzyl ammonium chloride—0.1 g

### Example 13

The composition of example 13 is: water—12.0 g; cocamidopropyl betaine (30%)—0.3 g; lauryl amine oxide (30%) 0.3 g; C9-C11 fatty alcohol 6EO—0.2 g; diethylene glycol mono ethyl ether—35.0 g; citric acid—0.1 g; monoethanol amine—2.0 g; C12-C16 alkyl dimethyl benzyl ammonium chloride—0.1 g

### Example 14

On a piece of aluminum foil an approximately 25 g conical pile of Purina® Tidy Cats® clumping cat litter and an approximately 25 g conical pile of ARM & HAMMER™ Double Duty Advanced Odor Control Clumping Litter were made. To the top of each of the conical piles was added 2 ml drop-wise of the formulation of example 12 of the present invention. The kitty litter was monitored for 24 hours and no sign of clumping was observed. When this test was repeated with water, the two clumping litters clumped very quickly, in less than 5 minutes.

### Example 15

On a piece of aluminum foil a 25 g conical pile of Purina® Tidy Cats® clumping cat litter and a 25 g conical pile of ARM & HAMMER™ Double Duty Advanced Odor Control Clumping Litter were made. To the top of each of the conical piles was added 2 ml drop-wise of the formulation of example 13 of the present invention. The kitty litter was monitored for 24 hours and no sign of clumping was observed.

What is claimed is:

1. An all-in-one air cleaner/odor eliminator, surface disinfectant and surface multipurpose/all purpose cleaner free of phosphorous, alkyl phenol ethoxylate based surfactants, anionic surfactants, silicates, heavy metals, abrasives with little volatile organic compounds and is not flammable having a near neutral pH and requiring less than 8 foot pounds of work to clean consisting of a water solution of cationic surfactants, nonionic surfactants, quaternary ammonium compounds, pH adjusters and pH buffers.
